(19) United States
(12) Patent Application Publication
(10) Pub. No.: US 2026/0052546 A1
(43) Pub. Date: Feb. 19, 2026

(54) CONTENTION WINDOW SIZE ADJUSTMENT FOR SIDELINK UNLICENSED BAND

(71) Applicant: Apple Inc., Cupertino, CA (US)

(72) Inventors: Huaning Niu, San Jose, CA (US); Wei Zeng, Saratoga, CA (US); Dawei Zhang, Saratoga, CA (US); Weidong Yang, San Diego, CA (US); Hong He, San Jose, CA (US); Haitong Sun, Cupertino, CA (US); Sigen Ye, San Diego, CA (US); Chunhai Yao, Beijing (CN); Chunxuan Ye, San Diego, CA (US)

(21) Appl. No.: 19/101,130

(22) PCT Filed: Jul. 14, 2023
(86) PCT No.: PCT/US2023/027725

§ 371 Date: Feb. 4, 2025

Related U.S. Application Data
(60) Provisional application No. 63/396,664, filed on Aug. 10, 2022.

(51) Int. Cl. H04W 72/25; H04L 1/1812; H04W 74/0808

(52) U.S. Cl. CPC H04W 72/25; H04L 1/1812; H04W 74/0808

(57) ABSTRACT

Systems, methods, and circuitries are provided for a UE performing sidelink (SL) communication in unlicensed spectrum to update contention window size (CWS). In one example, a method includes, during a sidelink (SL) channel occupancy time (COT), transmitting one or more physical sidelink shared channels (PSSCHs) transmissions to one or more respective receiving (RX) UEs according. Each PSSCH includes one or more transport blocks (TBs) and is associated with a channel access priority class (CAPC). The UE updates the CWS for the CAPC based on feedback received with respect to the one or more PSSCHs associated with the CAPC and transmits subsequent PSSCH associated with the CAPC based on the updated CWS.

### BACKGROUND

Sidelink communication is performed between UEs with limited assistance from the network and forms the basis for vehicle to everything (V2X) communication systems. Sidelink communication is distinguished from downlink communication (network access point (AP) to user equipment (UE)) and uplink communication (UE to AP).

One limiting factor in wireless innovation is the availability of spectrum. To mitigate this, the unlicensed spectrum has been an area of interest to expand the availability of Long Term Evolution (LTE) and New Radio (NR). In this context, recent releases of the 3GPP specification support LTE and NR uplink/downlink operation in the unlicensed spectrum.

### BRIEF DESCRIPTION OF THE DRAWINGS

Some examples of circuits, apparatuses and/or methods will be described in the following by way of example only. In this context, reference will be made to the accompanying figures.

FIGS. 1A, 1B, and 1C schematically illustrates various modes of sidelink communication, in accordance with various aspects disclosed.

FIG. 2 illustrates an example sidelink channel occupancy time, in accordance with various aspects disclosed.

FIG. 3 illustrates an example series of sidelink channel occupancy times, in accordance with various aspects disclosed.

FIG. 4 is a flow diagram illustrating an example method of updating a contention window size during unicast sidelink communication, according to various aspects disclosed.

FIG. 5 is a flow diagram illustrating an example method of updating a contention window size during unicast sidelink communication, according to various aspects disclosed.

FIGS. 6A, 6B, 6C, and 6C illustrate various example reference durations, according to various aspects disclosed.

FIG. 7 is a flow diagram illustrating an example method of updating a contention window size during groupcast mode 2 sidelink communication, according to various aspects disclosed.

FIG. 8 illustrates an example of an infrastructure equipment (e.g., base station), in accordance with various aspects disclosed.

FIG. 9 illustrates an example of a UE, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Sidelink (SL) communication, as distinguished from uplink (UL) or downlink (DL) communication, is continuing to be developed with many additional features being provided in Release 17 of the 3GPP specification. As currently configured, sidelink communication does not include several features supported in UL/DL communication. A few of these unsupported features will be summarized here to provide context for some of the proposed solutions.

Code block group (CBG) based physical downlink shared channel (PDSCH) transmission and hybrid automatic repeat request (HARQ) divides a transport block (TB) into smaller code blocks and the smaller code blocks are grouped into code block groups. The receiving device provides separate HARQ feedback for each CBG, rather than providing feedback for the entire TB. This allows for only those CBGs that are non-acknowledged (NACKed) to be re-transmitted, rather than re-transmitting an entire TB. CBG based transmission and HARQ are not currently supported by the 3GPP specification for sidelink communication.

Transmission time interval (TTI) bundling or slot aggregation is when the same TB is transmitted in PDSCH in a “burst” across multiple TTIs. This may be done for the sake of redundancy and provide a higher chance of successful transmission. This type of transmission is not currently supported by the 3GPP specification for sidelink communication.

In NR, PDSCH transmission may begin in any symbol of a slot which is different than in long term evolution (LTE) in which PDSCH is always allocated a full subframe. When the PDSCH does not use all symbols in a slot, it is called a partial slot allocation. This type of transmission is not currently supported by the 3GPP specification for sidelink communication.

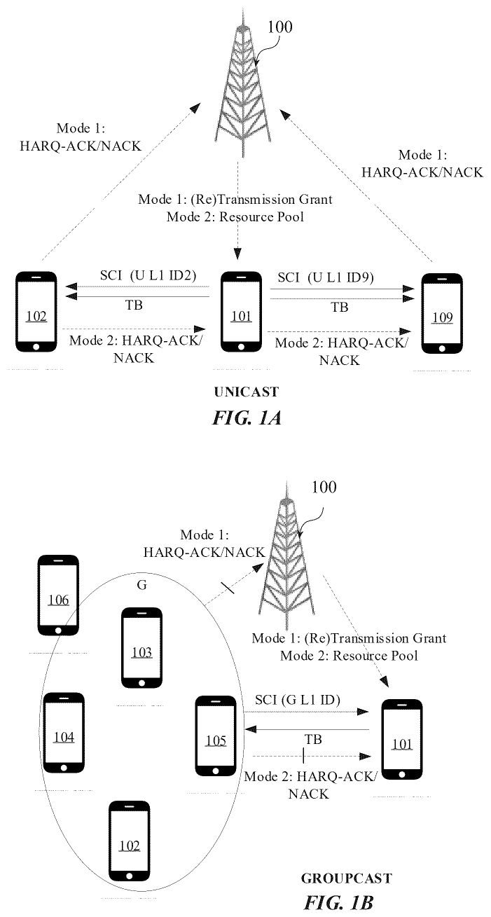

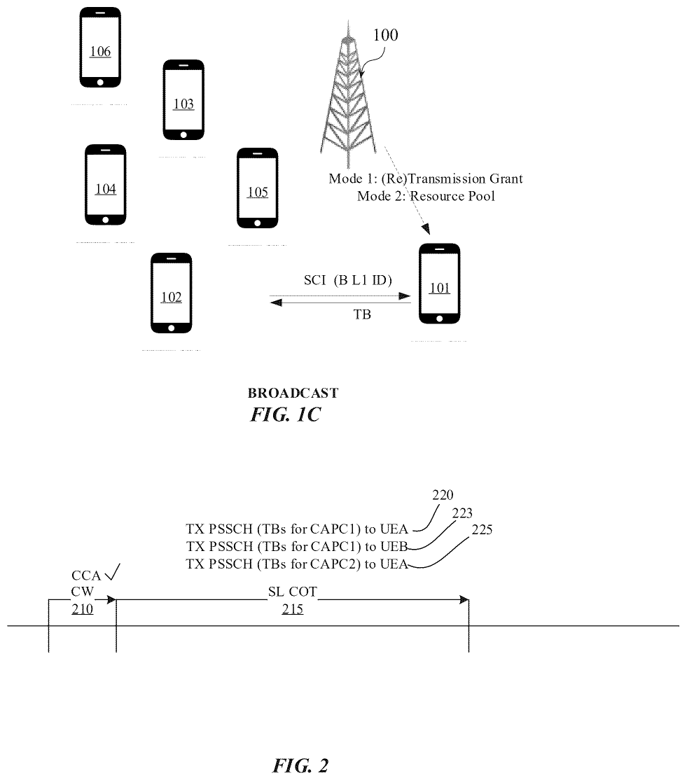

FIGS. 1A-1C are block diagrams of a wireless communication network in which wireless communication devices (e.g., user equipment (UE), or more generically “devices”) use unicast, groupcast, and broadcast sidelink communication, respectively. Each UE in the network includes baseband circuitry that includes one or more processors configured to perform various types of sidelink communication. For the purposes of this description, when a “UE” or “device” is described as performing some function, it can be understood that it is the processor(s) in the baseband circuitry, in conjunction with memory and/or transceivers(s) in some instances, that is performing the function. An example wireless communication device, including baseband circuitry, is illustrated in more detail in FIG. 9.

Sidelink communication may be performed according to one of two modes. In mode 1 the network controls resource allocation and receives feedback for transport blocks (TBs) transmitted between UEs (e.g., by way of signals transmitted or received by a base station or network node 100). In one example, resources for sidelink transmission are signaled to the transmitting UE as transmission grants. When the network determines that a TB was not decoded by the receiving (RX) UE, the network transmits a retransmission grant to the transmitting (TX) UE indicating resources to be used to retransmit the TB. Thus, in general a transmission grant for a next set of TBs may imply a positive feedback result for previously transmitted TBs while a retransmission grant for previously transmitted TBs may imply a negative feedback result for the previously transmitted TBs.

In mode 2, the network preconfigures a pool of sidelink resources from which a TX UE selects resources to transmit TBs to another UE without requiring specific allocation from the network. In mode 2, feedback for TBs is provided to the TX UE by way of hybrid automatic repeat request (HARQ) acknowledgment/non-acknowledgement (ACK/NACK) signals transmitted on a physical sidelink feedback channel (PSFCH).

Depending on whether the TX device is going to perform a unicast, groupcast, or broadcast transmission of data, the TX device determines (e.g., via higher layer signaling) a Layer-1 destination identifier (L1 destination ID) that uniquely identifies one or more channels between the TX device 101 and a specific RX device (a unicast identifier), a group of RX devices (a groupcast identifier), or all RX devices (a broadcast identifier) in the wireless communication network. In one example, the channels identified by LI destination IDs are physical sidelink control channels (PSCCH).

In the unicast example of FIG. 1A, TX device 101 seeks to transmit data (e.g., one or more TBs) to RX device 102 and no other device. In mode 1, the TX device 101 requests resources for transmitting the data from the network and receives a transmission grant in response. In mode 2, the TX device selects resources from the pre-allocated sidelink resource pool. The TX device 101 uses a unicast LI destination ID for the device 102 to initiate communication with the RX device 102. TX device 101 sends sidelink control information (SCI) using PSCCH resources associated with the LI destination ID for RX device 102. The SCI instructs the RX device 102 how to subsequently receive a transport block (TB) of data from TX device 101. For example, the SCI includes the unicast L1 destination ID for the RX device 102 and identifies frequency and time resources that specify a physical sidelink shared channel (PSSCH) that will be used to transmit (and retransmit in certain circumstances) the TB.

The SCI may also instruct the RX device whether to provide feedback, such as an acknowledgement/negative acknowledgement (ACK/NACK) indication, to confirm receipt of the TB or to communicate that the TB was not received. To this end, the SCI may include a hybrid automatic repeat request (HARQ) process identifier that uniquely identifies the TB for use by the RX device in providing the feedback. In mode 1, the RX device will transmit the feedback to the network (e.g., by way of base station 100). When a NACK (or no feedback) is received by the network, the network will transmit a retransmission grant to the TX device 101 for retransmitting the TB(s) that were not decoded by the RX device 102. In mode 2, the RX device 102 will transmit the feedback to the TX device 101.

In FIG. 1A, the TX device 101 is performing unicast sidelink communication with an additional RX device 109. The unicast communication between the different pairs of devices is managed separately for each RX device by the TX device 101, as described above.

A TX device may utilize multiple data radio bearers (DRBs), associated with different channel access priority classes, to communicate with an RX device. The channel access priority classes are subject to different quality of service (QoS) requirements. For example, a TX device may utilize DRBs having a channel access priority class (CAPC) 1 for transmitting data encoding voice or V2X messages while data encoding buffered streaming video or TCP-based communication like email or chat may be carried by DRBs having a lower priority access, CAPC 3.

FIG. 1B illustrates groupcast sidelink communication in which the TX device 101 seeks to transmit data to a group G that includes several devices 102, 103, 104, 105 (while only four devices are in the illustrated group, a different number may be in a group). A Groupcast LI destination ID identifies PSCCH channel(s) monitored by devices in group G for SCI. To enable the groupcast communication, the TX device 101 determines the LI destination ID for the group G. TX device 101 sends SCI using the PSCCH resources associated with the LI destination ID for group G. The SCI instructs devices in group G how to subsequently receive a TB from device 101. For example, the SCI includes the groupcast L1 destination ID for the group G and identifies frequency and time resources that specify a physical sidelink shared channel (PSSCH) that will be used to transmit and retransmit (in certain circumstances) the TB. The selection of resources for sidelink communication and the channel used by RX devices for feedback are controlled by whether the sidelink communication is mode 1 or mode 2 as described above.

The SCI may indicate a groupcast option 1 or 2 that instructs the RX devices in the group G whether and how to provide feedback. In groupcast option 1, when feedback is enabled the only type of feedback provided by the RX device is NACK and in some examples, when a particular RX device is outside a communication range specified in the SCI the RX device does not provide any feedback. In groupcast option 2, when feedback is enabled, both ACK/NACK feedback are provided the by the RX device. The SCI may include a hybrid automatic repeat request (HARQ) process identifier that uniquely identifies the TB for use by the RX device in providing feedback.

FIG. 1C illustrates broadcast sidelink communication in which the TX device 101 seeks to transmit data to all devices in the network or to all devices in the network that are able to receive the transmitted data. A Broadcast LI destination ID identifies PSCCH channel(s) monitored by all devices in the network for SCI. To enable the broadcast communication, the device 101 determines the broadcast LI destination ID for the network. TX Device 101 sends SCI using the PSCCH resources associated with the broadcast LI destination ID for the network. The SCI instructs devices the network how to subsequently receive data from device 101. For example, the SCI includes the broadcast L1 destination ID and identifies frequency and time resources that specify a physical sidelink shared channel (PSSCH) that will be used to transmit and retransmit (in certain circumstances) the TB. The selection of resources for sidelink communication are controlled by whether the sidelink communication is mode 1 or mode 2 as described above. There is no feedback in broadcast communication.

Previous 3GPP releases support UL/DL communication in unlicensed spectrum (NR-U). 3GPP Release 18 will support sidelink communication in unlicensed spectrum. Referring to FIG. 2, a channel access mechanism is defined for sidelink communication in NR-U. As with UL/DL, devices may contend for access to the unlicensed frequency bands by performing clear channel assessment (CCA) and Listen-Before-Talk (LBT) procedures during a contention window (CW) 210. The CW has a length or size (CWS) that varies according to sensed channel conditions and other factors. Any device (e.g., TX UE, base station, network node, access point (AP), and so on) that intends to transmit in unlicensed spectrum first performs a channel sensing operation before initiating any transmission. Once a device has sensed a clear channel (e.g., by sensing less than a threshold amount of energy in the channel during the CW or detecting a particular sequence), the device acquires a SL channel occupancy time (COT) 215 during which the device can transmit its data payload and receive feedback signals from receiving UEs and/or the base station. The maximum SL COT has a predetermined length, which is set by a channel access priority class associated with a particular transmission.

For example, in FIG. 2, once the CCA is successful, during the SL COT 215 a TX UE may transmit PSSCH 220 that includes TBs with CAPC 1 to UE A, PSSCH 223 that includes TBs with CAPC 1 to UA B, and PSSCH 225 that includes TBs with CAPC2 to UE A. The TX UE may receive HARQ-ACK/NACK feedback on the PSFCH and/or receive transmission and retransmission grants on a Uu link from the base station at any time, not just during SL COT 215.

Depending on the LBT category, an additional back-off mechanism is adopted to avoid collisions when interference occurs during a previous transmission in unlicensed spectrum. The back-off mechanism includes increasing the CWS to a next value when interference is detected and reducing or resetting the CWS when interference is not detected. The manner in which the CWS is increased, the conditions under which the CWS may be reset to its minimum value, and/or a maximum value for the CWS may be controlled by local regulation. For example, ETSI EN 301 893 requires an exponential extension of the CWS during each adjustment (e.g. ((CW+1)×m)−1 with m≥2), meaning that the “next value” of CWS is the result of the prescribed formula, unless the calculated value would violate a maximum CWS. In other examples, a series of CWS values may be preconfigured in which case, the next higher value is selected to increase the CWS.

In both LTE and NR, the CW update process is defined separately for UL and DL based on HARQ design and scheduling differences between UL and DL. In LTE and NR, DL/US COT and CWS are managed on a per CAPC basis.

A CWS update process should be established for sidelink communication based on sidelink HARQ design and scheduling. Described herein are systems, methods, and circuitries that update CWS for sidelink communication in unlicensed spectrum (SL-U) and/or determine an appropriate reference duration for sensing feedback when determining whether to update the CWS.

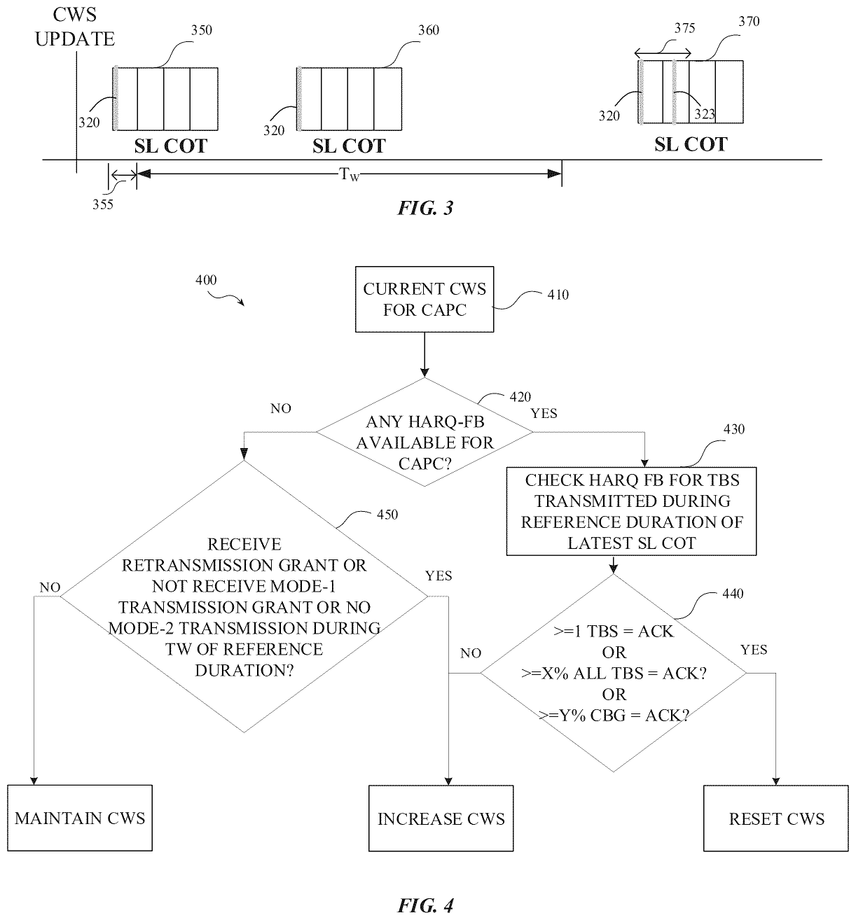

FIG. 3 illustrates a series of SL COTs 350, 360, 370 obtained by a TX UE. Each SL COT is illustrated as including four full slots. The length of the SL COT may include any number of partial or full slots and may vary over time. In the latest SL COT 370, the TX UE transmits PSSCH 320 and PSSCH 323, which may be to different RX UEs and/or for different CAPCs. It can be seen that PSSCH 320 starts at a beginning of a full slot in the SL COT while PSSCH 323 starts at a partial slot. While each SL COT is illustrated as beginning at a slot boundary, in some examples, the SL COT may begin at a partial slot.

### Unicast SL CWS Update Per CAPC Basis

FIG. 4 is a flow diagram outlining an example method 400 for updating CWS on a per CAPC basis. The method 400 may be performed by a TX UE for each CAPC for which it is performing unicast SL communication. In this technique, the CWS is updated based on feedback received with respect to all TBs with the CAPC, including feedback from any of a plurality of UEs with which the TX UE is performing unicast communication. At 410, the CWS has a current value for the CAPC. This value may have been previously updated using the method 400 or be a default or preconfigured value for the CAPC. At 420, the TX UE determines whether it has received any HARQ feedback (e.g., via PSFCH). As previously mentioned, depending on the mode of unicast operation, HARQ feedback may not be configured and instead transmission/retransmission grants may be received from a base station to control re-transmission of TBs when necessary. If the TX UE has received HARQ feedback, at 430, the TX UE analyzes HARQ feedback received for TBs transmitted during a reference duration of a latest SL COT (e.g., SL COT 370 of FIG. 3).

At 440, one or more CWS reset criteria are applied to the HARQ feedback for TBs transmitted during the reference duration. For example, if at least one HARQ-ACK is received for TBs transmitted for the CAPC during the reference duration, the CWS may be reset to a minimum value. If more than a predetermined proportion (X %) of TBs transmitted for the CAPC during the reference duration were acknowledged by HARQ-ACK, the CWS may be reset to a minimum value. In one example, X is 20%. If more than a predetermined proportion (Y %) of CBGs for TBs transmitted during the reference duration for the CAPC were acknowledged by HARQ-ACK, the CWS may be reset to a minimum value. In one example, Y is less than X (e.g., 10%). If none of the CWS reset criteria are met, the CWS may be increased to its next value.

Returning to 420, if no HARQ feedback has been received, the method proceeds to 450 and the TX UE determines whether any transmission grants or retransmission grants have been received during a window of predetermined length after a reference duration in an earliest SL COT since the last CWS update. Referring again to FIG. 3, in SL COT 350, 360, and 370 the TX UE transmitted PSSCH 320 to a first UE. In SL COT 370 the TX UE also transmitted PSSCH 323 to a second UE. In FIG. 3, with respect to the illustrated CAPC, SL COT 350 is the earliest SL COT since a most recent CWS update for the CAPC.

The window of predetermined length Tw that is applied at 450 in FIG. 4 is illustrated in FIG. 3. The window starts at the expiration of a reference duration 355 of the earliest SL COT 350. Note that the reference duration 355 may be different than reference duration 375 of SL COT 370 as will be described in more detail below. The predetermined length may be preconfigured or determined by the UE based on characteristics of the SL transmission. In one example, the predetermined length is calculated according to max(TA, TB+1) milliseconds, where TA is a constant, such as 5 ms and TB is the duration of the transmission burst from the start of the reference duration in milliseconds.

When, at 450, a retransmission grant was received during the window (implying that previously transmitted TBs were not decoded), or no mode-1 transmission grant was received during the window, or no mode-2 transmission occurs during the window, the CWS may be increased to the next value. When, at 450, a retransmission grant was not received during the window, or a mode-1 transmission grant was received during the window, or a mode-2 transmission occurs during the window (implying that previously transmitted TBs were decoded), the CWS may be maintained.

### Unicast SL CWS Update per Unicast Pair per CAPC Basis

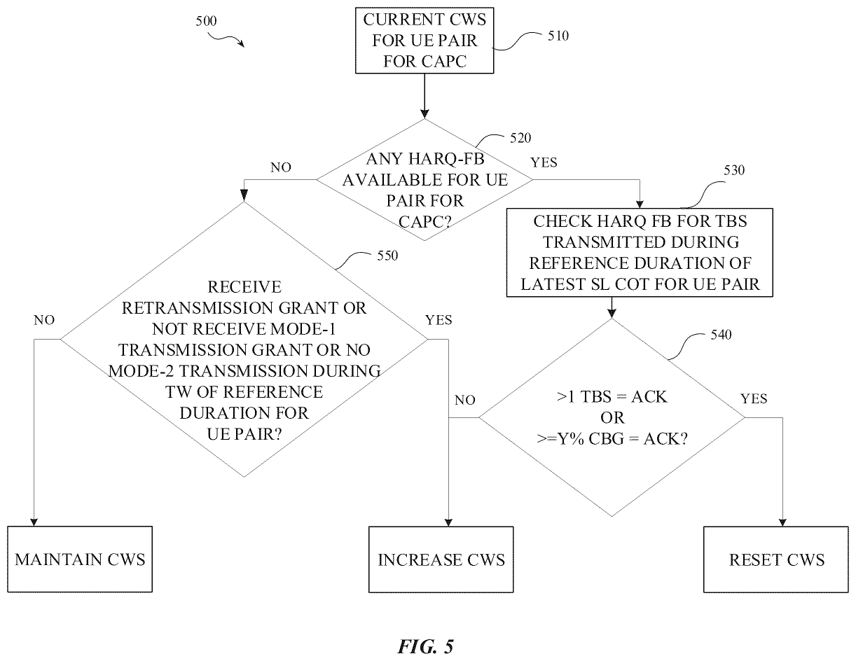

FIG. 5 is a flow diagram outlining an example method 500 for updating CWS on a per unicast pair per CAPC basis. For the purposes of this description, a unicast pair refers to a particular TX UE and RX UE that are engaged in unicast SL communication. The method 500 may be performed by a TX UE for each RX UE with which it is performing unicast SL communication for the CAPC. In this technique, the CWS for each unicast pair is separately updated based on feedback from the RX UE of the unicast pair with respect to TBs with the CAPC. At 510, the CWS has a current value for the unicast pair and the CAPC. This value may have been previously updated using the method 500 or be a default or preconfigured value for the CAPC. At 520, the TX UE determines whether it has received any HARQ feedback (e.g., via PSFCH) from the RX UE in the unicast pair. As previously mentioned, depending on the mode of unicast operation, HARQ feedback may not be configured and instead transmission/retransmission grants may be received from a base station to control re-transmission of TBs when necessary. If the TX UE has received HARQ feedback from the RX UE, at 530, the TX UE analyzes HARQ feedback received for TBs transmitted to the RX UE during a reference duration of a latest SL COT (e.g., SL COT 370 of FIG. 3).

At 540, one or more CWS reset criteria are applied to the HARQ feedback for TBs transmitted to the RX UE during the reference duration. For example, if at least one HARQ-ACK is received for TBs transmitted to the RX UE for the CAPC during the reference duration, the CWS may be reset to a minimum value. In some instances, a higher threshold of number of received HARQ-ACK (e.g., greater than or equal to two ACK) may be used as criteria for CWS reset. If more than a predetermined proportion (Y %) of CBGs for TBs transmitted during the reference duration to the RX UE for the CAPC were acknowledged by HARQ-ACK, the CWS may be reset to a minimum value. In one example, Y is 10%. If none of the CWS reset criteria are met, the CWS for the CAPC/unicast pair may be increased to its next value.

Returning to 520, if no HARQ feedback has been received from the RX UE, the method proceeds to 550 and the TX UE determines whether any transmission grants or retransmission grants with respect to the RX UE have been received during a window of predetermined length after a reference duration in a earliest SL COT since the last CWS update. Referring again to FIG. 3, assuming the CWS update occurred with respect to the first RX UE, in SL COT 350, 360, and 370 the TX UE transmitted PSSCH 320 to a first UE. In SL COT 370 the TX UE also transmitted PSSCH 323 to a second RX UE. In FIG. 3, with respect to the first RX UE and the illustrated CAPC, SL COT 350 is the earliest SL COT since a most recent CWS update for the CAPC. The CWS for the second RX UE is managed separately.

The window of predetermined length Tw that is applied at 550 in FIG. 5 is illustrated in FIG. 3. The window starts at the expiration of a reference duration 355 of the earliest SL COT 350. Note that the reference duration 355 may be different than reference duration 375 of SL COT 370 as will be described in more detail below. The predetermined length may be preconfigured or determined by the UE based on characteristics of the SL transmission. In one example, the predetermined length is calculated according to max(TA, TB+1) milliseconds, where TA is a constant, such as 5 ms and TB is the duration of the transmission burst from the start of the reference duration in milliseconds.

When, at 550, a retransmission grant was received during the window or no transmission grant with respect to TBs for the RX UE was received during the window (implying that previously transmitted TBs were not decoded) the CWS may be increased to the next value. When, at 550, a retransmission grant was not received during the window or a transmission grant with respect to TBs for the RX UE was received during the window (implying that previously transmitted TBs to the RX UE were decoded) the CWS may be maintained.

### Reference Duration

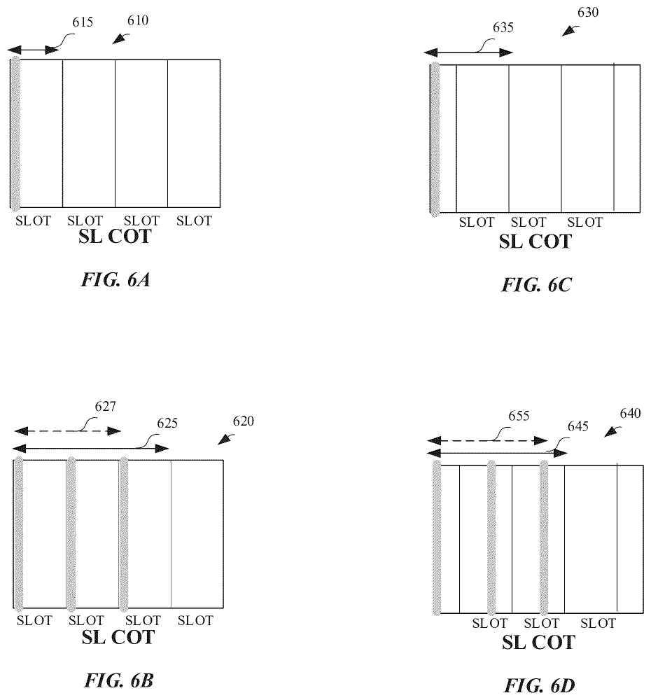

As already discussed, when HARQ feedback is configured, the CWS is updated based on HARQ feedback received for those TBs that were transmitted in PSSCH during a reference duration of the latest SLT COT. The reference duration of a particular SL COT may be determined based on the types of SL transmission that occurred (for the CAPC or CAPC/UE pair) during the SL COT. FIGS. 6A-6D illustrate different SL transmission schemes and example reference durations within latest SL COTs. A PSSCH is illustrated as the shaded region in FIGS. 6A-6D.

In FIG. 6A, each SL transmission is configured to occur in a single slot and starts at a slot boundary of the SL COT 610, in one example. In this case, the reference duration 615 is the first slot of the latest SL COT 610. In FIG. 6B, each SL transmission is configured to be repeated k times (e.g., k=3 is illustrated) in k slots (e.g., a PSSCH burst) and with each transmission starting at a slot boundary of the SL COT 620. In this case, the reference duration 625 is a continuous x slots of the latest SL COT 620. Alternatively, the reference duration (reference duration 627) may begin at the starting point of the latest SL COT 620 and finish at the end of the PSSCH burst.

In FIG. 6C, each SL transmission is configured to occur in a single slot with multiple starting positions (e.g. partial slot) enabled. In this case, the reference duration 635 is from the starting point of the SL COT 630 until the first full slot of the latest SL COT 630, in one example. In FIG. 6D, each SL transmission is configured to be repeated k times (e.g., k=3 is illustrated) in k slots with multiple starting positions (e.g. partial slot) enabled. In this case, the reference duration may be a continuous x slots (reference duration 645) after starting point of the latest SL COT 640. Alternatively, the reference duration (reference duration 655) may begin at the starting point of the latest SL COT 640 and finish at the end of the PSSCH burst.

In the case where partial slot is enabled and the beginning partial slot includes PSSCH associated with a first CAPC and the second, full, slot includes PSSCH associated with a different CAPC, the CWS for the CAPC used for CCA is maintained, regardless of whether the PSSCH associated with the CAPC used for CCA is in the beginning partial slot or the second, full slot. The CWS for the CAPC used for CCA may be updated based on subsequent feedback for PSSCH transmitted in later SL COTs.

### Groupcast Mode 1 CWS Update

In groupcast mode 1, an RX UE is configured to provide HARQ-NACK feedback but not HARQ-ACK feedback. The HARQ-NACK from the RX UEs in the group is communicated on a shared PFSCH resource. In groupcast mode 1, the CWS may not be adjusted, but rather set to a fixed size. The size may be a preconfigured minimum CWS for the CAPC, or some other related value. For example, the CWS for transmissions associated with a particular CAPC may be fixed at an average of a preconfigured minimum CWS and a preconfigured maximum CWS, or a middle value of a plurality of CWS values preconfigured for the CAPC.

In another example, in groupcast mode 1, the CWS may be increased to a next value in response to receiving HARQ-NACK feedback for one or more TBs transmitted to the group during the reference duration. The CWS may be increased for each SL COT in which HARQ-NACK is received until a preconfigured maximum CWS is reached. When the CWS reaches the maximum value, the CWS may be reset to a preconfigured minimum CWS value immediately, or after a defined period of time or number of subsequent SL COTs.

### Groupcast Mode 2 CWS Update

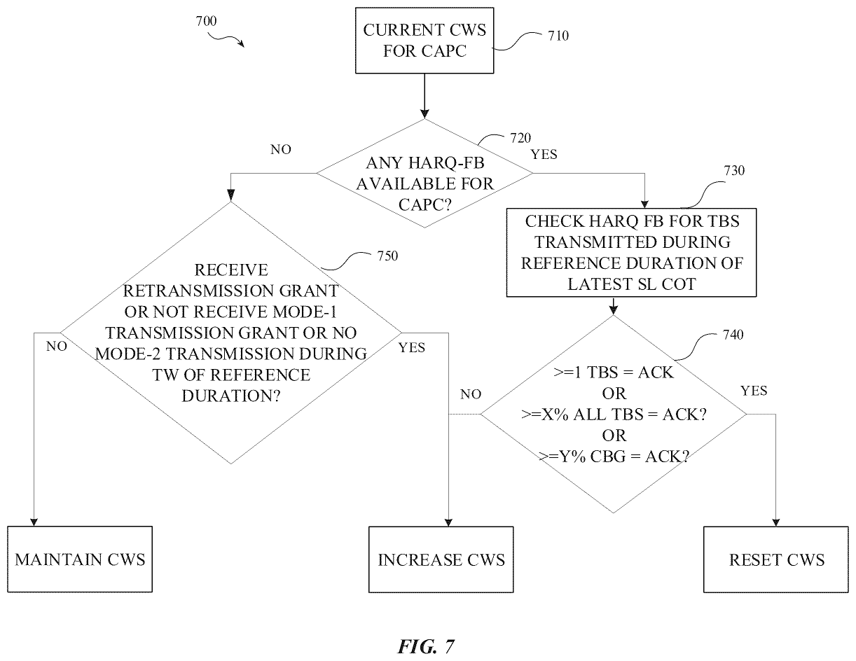

In groupcast mode 2, each RX UE provides HARQ ACK/NACK feedback using its own PSFCH resource. FIG. 7 is a flow diagram outlining an example method 700 for updating CWS on a per CAPC basis when groupcast mode 2 communication is performed. The method 700 may be performed by a TX UE for each CAPC for which it is performing groupcast mode 2 SL communication. In this technique, the CWS is updated based on feedback received with respect to all TBs with the CAPC, including feedback from any of the RX UEs in the group. At 710, the CWS has a current value for the CAPC. This value may have been previously updated using the method 700 or be a default or preconfigured value for the CAPC. At 720, the TX UE determines whether it has received any HARQ feedback (e.g., via the dedicated PSFCHs). As mentioned previously, depending on the mode of unicast operation, HARQ feedback may not be configured and instead transmission/retransmission grants may be received from a base station to control re-transmission of TBs when necessary. If the TX UE has received HARQ feedback, at 730, the TX UE analyzes HARQ feedback received for TBs transmitted during a reference duration of a latest SL COT (e.g., SL COT 370 of FIG. 3).

At 740, one or more CWS reset criteria are applied to the HARQ feedback for TBs transmitted during the reference duration. For example, if at least one HARQ-ACK is received for TBs transmitted for the CAPC during the reference duration, the CWS may be reset to a minimum value. In some instances, a higher threshold of number of received HARQ-ACK (e.g., greater than or equal to two ACK) may be used as criteria for CWS reset. If more than a predetermined proportion (X %) of TBs transmitted for the CAPC during the reference duration were acknowledged by HARQ-ACK, the CWS may be reset to a minimum value. In one example, X is 20%. If more than a predetermined proportion (Y %) of CBGs for TBs transmitted during the reference duration for the CAPC were acknowledged by HARQ-ACK, the CWS may be reset to a minimum value. In one example, Y is less than X (e.g., 10%). If none of the CWS reset criteria are met, the CWS may be increased to its next value.

Returning to 720, if no HARQ feedback has been received, the method proceeds to 750 and the TX UE determines whether any transmission grants or retransmission grants have been received during a window of predetermined length after a reference duration in an earliest SL COT since the last CWS update. Referring again to FIG. 3, assume that in SL COT 350, 360, and 370 the TX UE transmitted PSSCH 320 to a first group of RX UEs. In SL COT 370 the TX UE also transmitted PSSCH 323 to a unicast UE. In FIG. 3, with respect to the group and CAPC, SL COT 350 is the earliest SL COT since a most recent CWS update for the CAPC.

The window of predetermined length Tw that is applied at 750 in FIG. 7 is illustrated in FIG. 3. The window starts at the expiration of a reference duration 355 of the earliest SL COT 350. The predetermined length may be preconfigured or determined by the UE based on characteristics of the SL transmission. In one example, the predetermined length is calculated according to max(TA, TB+1) milliseconds, where TA is a constant, such as 5 ms and TB is the duration of the transmission burst from the start of the reference duration in milliseconds.

When, at 750, a retransmission grant was received during the window (implying that previously transmitted TBs were not decoded) or no mode-1 transmission grant was received during the window or no mode-2 transmission occurs during the window the CWS may be increased to the next value. When, at 750, a retransmission grant was not received during the window, or a mode-1 transmission grant was received during the window, or a mode-2 transmission occurs during the window (implying that previously transmitted TBs were decoded) the CWS may be maintained.

### CWS Update for Broadcast SL

There is no feedback mechanism for broadcast SL communication, thus the CWS for a CAPC may not be determined based on feedback for TBs transmitted by way of broadcast. In one example, when the TX UE is also performing unicast or groupcast SL communication, the TX UE may use the same CWS as is currently in use for the CAPC for unicast or groupcast communication. In another example, the CWS is fixed at a preconfigured minimum CWS or preconfigured minimum CWS for the CAPC. Alternatively, the CWS may be fixed at a preconfigured broadcast CWS, which may be configured on a per CAPC basis and may be longer than minimum CWS values configured for unicast or groupcast. In yet another example, the TX UE may randomly select a CWS prior to each CCA process or periodically prior to two or more CCA processes.

Several flow diagrams outlining example methods have been provided. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

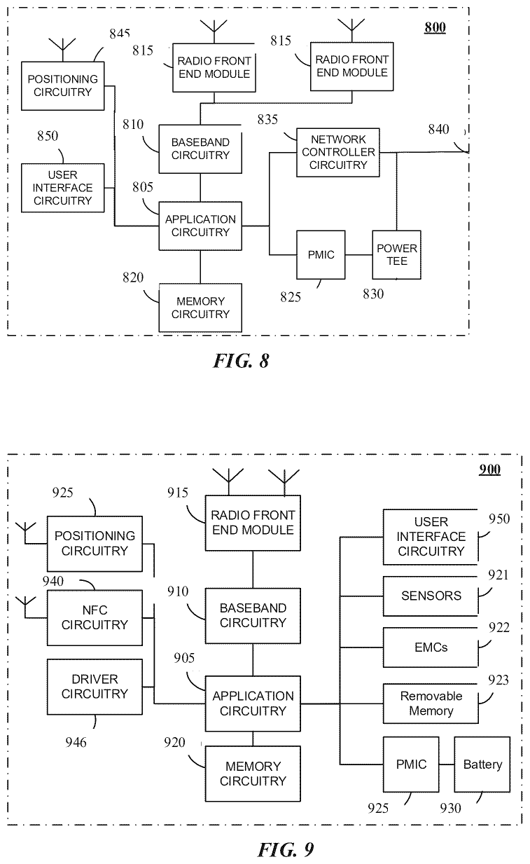

FIG. 8 illustrates an example of infrastructure equipment 800 in accordance with various aspects. The infrastructure equipment 800 (or “system 800”) may be implemented as a base station, radio head, RAN node such as the BS 100 of FIGS. 1A-1C and/or any other element/device discussed herein. The system 800 may support sidelink communication as described with respect to FIGS. 1A-1C, such as, for example, communicating to a UE an indication of a pool of allocated sidelink resources (mode-2) or transmitting transmission grants or retransmission grants (mode-1).

The system 800 includes application circuitry 805, baseband circuitry 810, one or more radio front end modules (RFEMs) 815, memory circuitry 820, power management integrated circuitry (PMIC) 825, power tee circuitry 830, network controller circuitry 835, network interface connector 840, satellite positioning circuitry 845, and user interface circuitry 850. In some aspects, the device 800 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations.

Application circuitry 805 includes circuitry such as, but not limited to one or more processors (or processor cores), cache memory, and one or more of low drop-out voltage regulators (LDOs), interrupt controllers, serial interfaces such as SPI, 12C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 805 may be coupled with or may include memory/storage elements and may be configured to execute instructions stored in the memory/storage to enable various applications or operating systems to run on the system 800. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 805 may comprise, or may be, a special-purpose processor/controller to operate according to the various aspects herein. As examples, the processor(s) of application circuitry 805 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 800 may not utilize application circuitry 805, and instead may include a special-purpose processor/controller to process IP data received from an EPC or 5GC, for example.

User interface circuitry 850 may include one or more user interfaces designed to enable user interaction with the system 800 or peripheral component interfaces designed to enable peripheral component interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 8 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 9 illustrates an example of a UE platform 900 (or “device 900”) in accordance with various aspects. In aspects, the UE platform 900 may be suitable for use as UEs 101-109 of FIGS. 1A-1C, and/or any other element/device discussed herein. The platform 900 may include any combinations of the components shown in the example. The components of platform 900 may be implemented as integrated circuits (ICs), portions thereof, discrete electronic devices, or other modules, logic, hardware, software, firmware, or a combination thereof adapted in the computer platform 900, or as components otherwise incorporated within a chassis of a larger system. The block diagram of FIG. 9 is intended to show a high level view of components of the computer platform 900. However, some of the components shown may be omitted, additional components may be present, and different arrangement of the components shown may occur in other implementations.

Application circuitry 905 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 905 may include a general or special purpose processor, such as an A-series processor (e.g., the A13 Bionic), available from Apple® Inc., Cupertino, CA or any other such processor. The processors of the application circuitry 905 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components are formed into a single integrated circuit, or a single package.

The baseband circuitry or processor 910 may be implemented, for example, as a solder-down substrate including one or more integrated circuits, a single packaged integrated circuit soldered to a main circuit board or a multi-chip module containing two or more integrated circuits. The baseband circuitry or processor 910 may include hardware, or stored executable instructions that cause the UE to transmit data to one or more other UEs using SL communication protocols (e.g., unicast, groupcast, broadcast), receive transmission grants and retransmission grants from a base station (mode-1), receive HARQ-ACK or HARQ-NACK feedback, and/or adjust the CWS used for operation in unlicensed spectrum based on feedback/transmission grants, retransmission grants.

The platform 900 may also include interface circuitry (not shown) that is used to connect external devices with the platform 900. The external devices connected to the platform 900 via the interface circuitry include sensor circuitry 921 and electro-mechanical components (EMCs) 922, as well as removable memory devices coupled to removable memory circuitry 923.

A battery 930 may power the platform 900, although in some examples the platform 900 may be mounted deployed in a fixed location, and may have a power supply coupled to an electrical grid. The battery 930 may be a lithium ion battery, a metal-air battery, such as a zinc-air battery, an aluminum-air battery, a lithium-air battery, and the like. In some implementations, such as in V2X applications, the battery 930 may be a typical lead-acid automotive battery.

Example 1 is an apparatus for a user equipment (UE) operating in unlicensed spectrum, including one or more processors configured to cause the UE to, during a sidelink (SL) channel occupancy time (COT), transmit one or more physical sidelink shared channels (PSSCHs) transmissions to one or more respective receiving (RX) UEs according to a SL communication protocol, wherein each PSSCH includes one or more transport blocks (TBs), wherein each PSSCH transmission is associated with a channel access priority class (CAPC); update a contention window size for the CAPC based on feedback received with respect to the one or more PSSCHs associated with the CAPC; and transmit subsequent PSSCH associated with the CAPC based on the updated CWS.

Example 2 includes the subject matter of example 1, including or omitting optional elements, wherein the one or more processors are configured to update the CWS in response to receiving Hybrid Automatic Repeat Request (HARQ) acknowledgement (ACK) or non-acknowledgement (NACK) feedback with respect to TBs transmitted with the CAPC during a reference duration within the SL COT.

Example 3 includes the subject matter of example 2, including or omitting optional elements, wherein the one or more processors are configured to, when HARQ-ACK or HARQ-NACK feedback is not received, update the CWS based on whether a mode-1 transmission grant or retransmission grant is received or a mode-2 transmission occurs for TBs associated with the CAPC during a time window of predetermined length after the reference duration of an earliest SL COT since a last CWS update.

Example 4 includes the subject matter of example 1, including or omitting optional elements, wherein the one or more processors are configured to reset the CWS to a minimum value in response to receiving a HARQ-ACK for at least one of the TBs transmitted for the CAPC during the reference duration within the SL COT and increase the CWS to a next level in response to receiving at least one HARQ-NACK and no HARQ-ACKs for TBs transmitted for the CAPC during the reference duration within the SL COT.

Example 5 includes the subject matter of example 1, including or omitting optional elements, wherein the one or more processors are configured to reset the CWS to a minimum value in response to receiving a HARQ-ACK for at least a predetermined proportion of the TBs transmitted for the CAPC during the reference duration within the SL COT.

Example 6 includes the subject matter of example 1, including or omitting optional elements, wherein the one or more processors are configured to reset the CWS to a minimum value in response to receiving a HARQ-ACK for at least a predetermined proportion of code block groups (CBGs) for the TBs transmitted for the CAPC during the reference duration within the SL COT.

Example 7 includes the subject matter of example 1, including or omitting optional elements, wherein the one or more processors are configured to increase the CWS to a next value in response to receiving a HARQ-ACK for less than a predetermined proportion of the TBs transmitted for the CAPC during the reference duration within the SL COT.

Example 8 includes the subject matter of example 7, including or omitting optional elements, wherein the one or more processors are configured to increase the CWS according to (2*CWS+1).

Example 9 includes the subject matter of example 1, including or omitting optional elements, wherein the one or more processors are configured to increase the CWS to a next value in response to not receiving a HARQ-ACK for at least a predetermined proportion of code block groups (CBGs) for the TBs transmitted for the CAPC during the reference duration within the SL COT.

Example 10 includes the subject matter of example 9, including or omitting optional elements, wherein the one or more processors are configured to increase the CWS according to (2*CWS+1).

Example 11 includes the subject matter of example 1, including or omitting optional elements, wherein the one or more processors are configured to increase the CWS to a next value in response to receiving no HARQ-ACKs or HARQ-NACKs for the TBs transmitted for the CAPC during the reference duration within the SL COT; and not receiving a mode-1 transmission grant, or receiving retransmission grant, or a mode-2 transmission not occurring for TBs with the CAPC within a time window of predetermined length after expiration of a reference duration of an earliest SL COT since a last update of the CWS.

Example 12 includes the subject matter of example 1, including or omitting optional elements, wherein the one or more processors are configured to increase the CWS according to (2*CWS+1).

Example 13 includes the subject matter of example 11, including or omitting optional elements, wherein the predetermined length is determined according to max (TA, TB+1) milliseconds, where TA is 5 milliseconds and TB is the duration of the PSSCH from the start of the reference duration.

Example 14 includes the subject matter of example 1, including or omitting optional elements, wherein the one or more processors are configured to maintain the CWS at the current value in response to receiving no HARQ-ACKs or HARQ-NACKs for the TBs transmitted for the CAPC during the reference duration within the SL COT; and not receiving a retransmission grant, or receiving a mode-1 transmission grant, or a mode-2 transmission occurring for TBs with the CAPC during a time window of predetermined length after expiration of a reference duration of an earliest SL COT since a last update of the CWS.

Example 15 includes the subject matter of example 14, including or omitting optional elements, wherein the predetermined length is determined according to max (TA, TB+1) milliseconds, where TA is 5 milliseconds and TB is the duration of the PSSCH from the start of the reference duration.

Example 16 includes the subject matter of example 1, including or omitting optional elements, wherein the one or more processors are configured to adjust the CWS for a CAPC on a per receiving (RX) UE basis, such that the CWS for a CAPC and RX UE is updated based on feedback received with respect to TBs transmitted to the RX UE during the reference duration.

Example 17 includes the subject matter of example 1, including or omitting optional elements, wherein the one or more processors are configured to, for each CAPC, increase a contention window size (CWS) to a next value in response to receiving a HARQ-NACK with respect to a TB transmitted during a reference duration to a group of RX UEs for the CAPC.

Example 18 includes the subject matter of example 1, including or omitting optional elements, wherein the one or more processors are configured to reset the CWS to a minimum CWS value when the increased CWS value exceeds a preconfigured maximum CWS value.

Example 19 includes the subject matter of example 1, including or omitting optional elements, wherein the one or more processors are configured to reset the CWS to a minimum CWS value after the UE has transmitted PSSCH according to a maximum CWS for a preconfigured period of time.

Example 20 includes the subject matter of example 1, including or omitting optional elements, wherein the reference duration includes a duration of a first slot of the SL COT.

Example 21 includes the subject matter of example 1, including or omitting optional elements, wherein the reference duration includes k continuous first full slots in the SL COT when the UE transmits x PSSCH in the SL COT.

Example 22 includes the subject matter of example 1, including or omitting optional elements, wherein the reference duration starts at a partial slot starting point of the SL COT and ends at a first full slot after the partial slot starting point of the SL COT.

Example 23 includes the subject matter of example 1, including or omitting optional elements, wherein the reference duration starts at a partial slot starting point of the SL COT and ends at partial slot end point of the PSSCH in the SL COT.

Example 24 includes the subject matter of example 1, including or omitting optional elements, wherein the reference duration starts at a partial slot starting point of the SL COT and ends k continuous full slots after the partial slot starting point of the SL COT when the UE transmits x multiple PSSCH for the CAPC in the SL COT.

Example 25 includes the subject matter of example 1, including or omitting optional elements, wherein the reference duration starts at a partial slot starting point of the SL COT and ends at partial slot end point of a PSSCH burst in the SL COT when the UE transmits x multiple PSSCH for the CAPC in the SL COT.

Example 26 is an apparatus for a user equipment (UE) performing sidelink communication in unlicensed spectrum, including one or more processors configured to cause the UE to during a contention window for a channel access priority class (CPAC) having a fixed contention window size (CWS), perform clear channel assessment (CCA) to acquire a sidelink occupancy time (SL COT); and during the SL COT transmit signals encoding respective one or more transport blocks (TBs) in respective one or more physical sidelink shared channels (PSSCHs) to a group of one or more RX UEs, wherein each PSSCH is associated with the CAPC.

Example 27 includes the subject matter of example 26, including or omitting optional elements, wherein the CWS includes a preconfigured minimum CWS value.

Example 28 includes the subject matter of example 26, including or omitting optional elements, wherein the CWS includes a preconfigured maximum CWS value.

Example 29 includes the subject matter of example 26, including or omitting optional elements, wherein the CWS includes a midpoint value of a preconfigured minimum CWS value and a preconfigured maximum CWS value.

Example 30 includes the subject matter of example 26, including or omitting optional elements, wherein the CWS includes a preconfigured minimum CWS value for the CAPC.

Example 31 includes the subject matter of example 26, including or omitting optional elements, wherein the CWS includes a preconfigured maximum CWS value for the CAPC.

Example 32 includes the subject matter of example 26, including or omitting optional elements, wherein the CWS includes a midpoint value of a preconfigured minimum CWS value and a preconfigured maximum CWS value for the CAPC.

Example 33 includes the subject matter of example 26, including or omitting optional elements, wherein the one or more processors are configured to randomly select a value for the CWS.

Example 34 includes the subject matter of example 26, including or omitting optional elements, wherein the CWS includes a preconfigured minimum CWS for broadcast communication.

Example 27 includes the subject matter of example 26, including or omitting optional elements, wherein the CWS includes a preconfigured minimum CWS for broadcast communication for the CAPC.

Example 36 is an apparatus for a user equipment (UE) operating in unlicensed spectrum, including one or more processors configured to cause the UE to, during a sidelink (SL) channel occupancy time (COT), transmit one or more physical sidelink shared channels (PSSCHs) transmissions to one or more respective receiving (RX) UEs according to a SL unicast communication protocol, wherein each PSSCH includes one or more transport blocks (TBs), wherein each PSSCH transmission is associated with a channel access priority class (CAPC). The one or more processors are configured to, for each CAPC, in response to receiving Hybrid Automatic Repeat Request (HARQ) acknowledgement (ACK) or non-acknowledgement (NACK) feedback, update a contention window size (CWS) for the CAPC based on feedback received with respect to TBs transmitted for the CAPC during a reference duration within the SL COT. The one or more processors are configured to, in response to not receiving HARQ-ACK or HARQ-NACK feedback, update the CWS for the CAPC based on whether a mode-1 transmission grant or retransmission grant is received or a mode-2 transmission occurs for TBs with the CAPC during a time window of predetermined length after the reference duration of an earliest SL COT since a last CWS update; and transmit subsequent PSSCH for the CAPC according to the unicast communication protocol based on the updated CWS.

Example 37 includes the subject matter of example 36, including or omitting optional elements, wherein the one or more processors are configured to reset the CWS to a minimum value in response to receiving a HARQ-ACK for at least one of the TBs transmitted for the CAPC during the reference duration within the SL COT and increase the CWS to a next level in response to receiving at least one HARQ-NACK and no HARQ-ACKs for TBs transmitted for the CAPC during the reference duration within the SL COT.

Example 38 includes the subject matter of example 36, including or omitting optional elements, wherein the one or more processors are configured to reset the CWS to a minimum value in response to receiving a HARQ-ACK for at least a predetermined proportion of the TBs transmitted for the CAPC during the reference duration within the SL COT.

Example 39 includes the subject matter of example 36, including or omitting optional elements, wherein the one or more processors are configured to reset the CWS to a minimum value in response to receiving a HARQ-ACK for at least a predetermined proportion of code block groups (CBGs) for the TBs transmitted for the CAPC during the reference duration within the SL COT.

Example 40 includes the subject matter of example 36, including or omitting optional elements, wherein the one or more processors are configured to increase the CWS to a next value in response to receiving a HARQ-ACK for less than a predetermined proportion of the TBs transmitted for the CAPC during the reference duration within the SL COT.

Example 41 includes the subject matter of example 40, including or omitting optional elements, wherein the one or more processors are configured to increase the CWS according to (2*CWS+1).

Example 42 includes the subject matter of example 40, including or omitting optional elements, wherein the one or more processors are configured to increase the CWS to a next value in response to not receiving a HARQ-ACK for at least a predetermined proportion of code block groups (CBGs) for the TBs transmitted for the CAPC during the reference duration within the SL COT.

Example 43 includes the subject matter of example 42, including or omitting optional elements, wherein the one or more processors are configured to increase the CWS according to (2*CWS+1).

Example 44 includes the subject matter of example 36, including or omitting optional elements, wherein the one or more processors are configured to increase the CWS to a next value in response to receiving no HARQ-ACKs or HARQ-NACKs for the TBs transmitted for the CAPC during the reference duration within the SL COT; and not receiving a mode-1 transmission grant, or receiving retransmission grant, or a mode-2 transmission not occurring for TBs with the CAPC within a time window of predetermined length after expiration of a reference duration of an earliest SL COT since a last update of the CWS.

Example 45 includes the subject matter of example 44, including or omitting optional elements, wherein the one or more processors are configured to increase the CWS according to (2*CWS+1).

Example 46 includes the subject matter of example 44, including or omitting optional elements, wherein the predetermined length is determined according to max (TA, TB+1) milliseconds, where TA is 5 milliseconds and TB is the duration of the PSSCH from the start of the reference duration.

Example 47 includes the subject matter of example 36, including or omitting optional elements, wherein the one or more processors are configured to maintain the CWS at the current value in response to receiving no HARQ-ACKs or HARQ-NACKs for the TBs transmitted for the CAPC during the reference duration within the SL COT; and not receiving a retransmission grant, or receiving a mode-1 transmission grant, or a mode-2 transmission occurring for TBs with the CAPC during a time window of predetermined length after expiration of a reference duration of an earliest SL COT since a last update of the CWS.

Example 48 includes the subject matter of example 47, including or omitting optional elements, wherein the predetermined length is determined according to max (TA, TB+1) milliseconds, where TA is 5 milliseconds and TB is the duration of the PSSCH from the start of the reference duration.

Example 49 includes the subject matter of example 36, including or omitting optional elements, wherein the reference duration includes a duration of a first slot of the SL COT.

Example 50 includes the subject matter of example 36, including or omitting optional elements, wherein the reference duration includes k continuous first full slots in the SL COT when the UE transmits x PSSCH in the SL COT.

Example 51 includes the subject matter of example 36, including or omitting optional elements, wherein the reference duration starts at a partial slot starting point of the SL COT and ends at a first full slot after the partial slot starting point of the SL COT.

Example 52 includes the subject matter of example 36, including or omitting optional elements, wherein the reference duration starts at a partial slot starting point of the SL COT and ends at partial slot end point of the PSSCH in the SL COT.

Example 53 includes the subject matter of example 36, including or omitting optional elements, wherein the reference duration starts at a partial slot starting point of the SL COT and ends k continuous full slots after the partial slot starting point of the SL COT when the UE transmits x multiple PSSCH for the CAPC in the SL COT.

Example 54 includes the subject matter of example 36, including or omitting optional elements, wherein the reference duration starts at a partial slot starting point of the SL COT and ends at partial slot end point of a PSSCH burst in the SL COT when the UE transmits x multiple PSSCH for the CAPC in the SL COT.

Example 55 is an apparatus for a user equipment (UE) operating in unlicensed spectrum, including one or more processors configured to cause the UE to update a contention window size (CWS). The one or more processors are configured to cause the UE to, during a sidelink (SL) channel occupancy time (COT), transmit respective signals encoding respective transport blocks (TBs) on physical sidelink shared channels (PSSCHs) to one or more respective receiving (RX) UEs according to a SL unicast communication protocol, wherein each PSSCH is associated with a channel access priority class (CAPC). The one or more processors are configured to, for each RX UE and each CAPC, in response to receiving Hybrid Automatic Repeat Request (HARQ) acknowledgement (ACK) or non-acknowledgement (NACK) feedback from the RX UE, update a contention window size (CWS) for the RX UE and CAPC based on feedback received with respect to TBs transmitted to the RX UE for the CAPC during a reference duration within the SL COT, and in response to not receiving HARQ-ACK or HARQ-NACK feedback from the RX UE, update the CWS for the CAPC/RX UE based on whether a mode-1 transmission grant or retransmission grant is received or a mode-2 transmission occurs for TBs with the CAPC and the RX UE during a time window of predetermined length after the reference duration of an earliest SL COT since a last CWS update for the CAPC/RX UE; and transmit subsequent PSSCH to the RX UE for the CAPC according to the unicast communication protocol based on the updated CWS.

Example 56 includes the subject matter of example 55, including or omitting optional elements, wherein the one or more processors are configured to reset the CWS to a minimum value in response to receiving a HARQ-ACK during the reference duration for at least one TB transmitted to the RX UE for the CAPC.

Example 57 includes the subject matter of example 55, including or omitting optional elements, wherein the one or more processors are configured to reset the CWS to a minimum value in response to receiving a HARQ-ACK for at least a predetermined proportion of code block groups (CBGs) for TBs transmitted to the RX UE for the CAPC.

Example 58 includes the subject matter of example 55, including or omitting optional elements, wherein the one or more processors are configured to increase the CWS to a next value in response to receiving a HARQ-ACK for less than a predetermined proportion of the TBs transmitted to the RX UE for the CAPC during the reference duration within the SL COT.

Example 59 includes the subject matter of example 58, including or omitting optional elements, wherein the one or more processors are configured to increase the CWS according to (2*CWS+1).

Example 60 includes the subject matter of example 55, including or omitting optional elements, wherein the one or more processors are configured to increase the CWS to a next value in response to not receiving a HARQ-ACK for at least a predetermined proportion of code block groups (CBGs) for the TBs transmitted to the RX UE for the CAPC during the reference duration within the SL COT.

Example 61 includes the subject matter of example 60, including or omitting optional elements, wherein the one or more processors are configured to increase the CWS according to (2*CWS+1).

Example 62 includes the subject matter of example 55, including or omitting optional elements, wherein the one or more processors are configured to increase the CWS to a next value in response to receiving no HARQ-ACKs or HARQ-NACKs for the TBs transmitted to the RX for the CAPC during the reference duration within the SL COT; and not receiving a mode-1 transmission grant for subsequent TBs for the RX UE or receiving a retransmission grant or a mode-2 transmission not occurring for TBs transmitted to the RX UE for the CAPC within a time window of predetermined length after expiration of a reference duration of an earliest SL COT since a last update of the CWS.

Example 63 includes the subject matter of example 62, including or omitting optional elements, wherein the one or more processors are configured to increase the CWS according to (2*CWS+1).

Example 64 includes the subject matter of example 62, including or omitting optional elements, wherein the predetermined length is determined according to max (TA, TB+1) milliseconds, where TA is 5 milliseconds and TB is the duration of the PSSCH from the start of the reference duration.

Example 65 includes the subject matter of example 55, including or omitting optional elements, wherein the one or more processors are configured to maintain the CWS at the current value in response to receiving no HARQ-ACKs or HARQ-NACKs for the TBs transmitted to the RX UE for the CAPC during the reference duration within the SL COT; and not receiving a retransmission grant, or receiving a mode-1 transmission grant, or a mode-2 transmission occurring for TBs for the RX UE and the CAPC during a time window of predetermined length after expiration of a reference duration of an earliest SL COT since a last update of the CWS.

Example 66 includes the subject matter of example 65, including or omitting optional elements, wherein the predetermined length is determined according to max (TA, TB+1) milliseconds, where TA is 5 milliseconds and TB is the duration of the PSSCH from the start of the reference duration.

Example 67 includes the subject matter of example 55, including or omitting optional elements, wherein the reference duration includes a duration of a first slot of the SL COT.

Example 68 includes the subject matter of example 55, including or omitting optional elements, wherein the reference duration includes k continuous first full slots in the SL COT when the UE transmits x PSSCH to the RX UE in the SL COT.

Example 69 includes the subject matter of example 55, including or omitting optional elements, wherein the reference duration starts at a partial slot starting point of the SL COT and ends at a first full slot after the partial slot starting point of the SL COT.

Example 70 includes the subject matter of example 55, including or omitting optional elements, wherein the reference duration starts at a partial slot starting point of the SL COT and ends at partial slot end point of the PSSCH for the RX UE in the SL COT.

Example 71 includes the subject matter of example 55, including or omitting optional elements, wherein the reference duration starts at a partial slot starting point of the SL COT and ends k continuous full slots after the partial slot starting point of the SL COT when the UE transmits x multiple PSSCH to the RX UE for the CAPC in the SL COT.

Example 72 includes the subject matter of example 55, including or omitting optional elements, wherein the reference duration starts at a partial slot starting point of the SL COT and ends at partial slot end point of a PSSCH burst in the SL COT when the UE transmits x multiple PSSCH to the RX UE for the CAPC in the SL COT.

Example 73 is an apparatus for a user equipment (UE) performing groupcast mode 1 communication in unlicensed spectrum, including one or more processors configured to cause the UE to, during a contention window for a channel access priority class (CPAC) having a fixed contention window size (CWS), perform clear channel assessment (CCA) to acquire a sidelink occupancy time (SL COT); and during the SL COT transmit respective signals encoding respective one or more transport blocks (TBs) in respective one or more physical sidelink shared channels (PSSCHs) to a group of one or more RX UEs according to a groupcast mode 1 communication protocol, wherein each PSSCH is associated with the CAPC.

Example 74 includes the subject matter of example 73, including or omitting optional elements, wherein the CWS includes a preconfigured minimum CWS value.

Example 75 includes the subject matter of example 73, including or omitting optional elements, wherein the CWS includes a preconfigured maximum CWS value.

Example 76 includes the subject matter of example 73, including or omitting optional elements, wherein the CWS includes a midpoint value of a preconfigured minimum CWS value and a preconfigured maximum CWS value.

Example 77 includes the subject matter of example 73, including or omitting optional elements, wherein the CWS includes a preconfigured minimum CWS value for the CAPC.

Example 78 includes the subject matter of example 73, including or omitting optional elements, wherein the CWS includes a preconfigured maximum CWS value for the CAPC.

Example 79 includes the subject matter of example 73, including or omitting optional elements, wherein the CWS includes a midpoint value of a preconfigured minimum CWS value and a preconfigured maximum CWS value for the CAPC.

Example 80 is an apparatus for a user equipment (UE) performing groupcast mode 1 communication in unlicensed spectrum, including one or more processors configured to cause the UE to, during a sidelink occupancy time (SL COT), transmit signals encoding one or more transport blocks (TBs) in one or more physical sidelink shared channels (PSSCHs) to a group of one or more respective RX UEs according to a groupcast mode 1 communication protocol, wherein each PSSCH is associated with a channel access priority class (CAPC); and for each CAPC, increase a contention window size (CWS) to a next value in response to receiving a HARQ-NACK for a TB transmitted during a reference duration to the group of RX UEs for the CAPC.

Example 81 includes the subject matter of example 80, including or omitting optional elements, wherein the one or more processors are configured to reset the CWS to a minimum CWS value when the increased CWS value exceeds a preconfigured maximum CWS value.

Example 82 includes the subject matter of example 80, including or omitting optional elements, wherein the one or more processors are configured to reset the CWS to a minimum CWS value after the UE has transmitted PSSCH according to a maximum CWS for a preconfigured period of time.

Example 83 includes the subject matter of example 80, including or omitting optional elements, wherein the reference duration includes a duration of a first slot of the SL COT.

Example 84 includes the subject matter of example 80, including or omitting optional elements, wherein the reference duration includes k continuous first full slots in the SL COT when the UE transmits x PSSCH to the RX UE in the SL COT.

Example 85 includes the subject matter of example 80, including or omitting optional elements, wherein the reference duration starts at a partial slot starting point of the SL COT and ends at a first full slot after the partial slot starting point of the SL COT.

Example 86 includes the subject matter of example 80, including or omitting optional elements, wherein the reference duration starts at a partial slot starting point of the SL COT and ends at partial slot end point of the PSSCH for the RX UE in the SL COT.

Example 87 includes the subject matter of example 80, including or omitting optional elements, wherein the reference duration starts at a partial slot starting point of the SL COT and ends k continuous full slots after the partial slot starting point of the SL COT when the UE transmits x multiple PSSCH to the RX UE for the CAPC in the SL COT.

Example 88 includes the subject matter of example 80, including or omitting optional elements, wherein the reference duration starts at a partial slot starting point of the SL COT and ends at partial slot end point of a PSSCH burst in the SL COT when the UE transmits x multiple PSSCH to the RX UE for the CAPC in the SL COT.

Example 89 is an apparatus for a user equipment (UE) performing groupcast mode 2 communication in unlicensed spectrum, including one or more processors configured to cause the UE to, during a sidelink (SL) channel occupancy time (COT), transmit one or more physical sidelink shared channels (PSSCHs) transmissions to a group of one or more respective receiving (RX) UEs according to a SL groupcast mode 2 communication protocol, wherein each PSSCH includes one or more transport blocks (TBs), wherein each PSSCH transmission is associated with a channel access priority class (CAPC). The one or more processors are configured to, for each CAPC, in response to receiving Hybrid Automatic Repeat Request (HARQ) acknowledgement (ACK) or non-acknowledgement (NACK) feedback, update a contention window size (CWS) for the CAPC based on feedback received with respect to TBs transmitted for the CAPC during a reference duration within the SL COT, and in response to not receiving HARQ-ACK or HARQ-NACK feedback, update the CWS for the CAPC based on whether a mode-1 transmission grant or retransmission grant is received or mode-2 transmission occurs for TBs with the CAPC during a time window of predetermined length after the reference duration of an earliest SL COT since a last CWS update; and transmit subsequent PSSCH for the CAPC according to the groupcast mode 2 communication protocol based on the updated CWS.

Example 90 includes the subject matter of example 89, including or omitting optional elements, wherein the one or more processors are configured to reset the CWS to a minimum value in response to receiving a HARQ-ACK for at least one of the TBs transmitted for the CAPC during the reference duration within the SL COT and increase the CWS to a next level in response to receiving at least one HARQ-NACK and no HARQ-ACKs for TBs transmitted for the CAPC during the reference duration within the SL COT.

Example 91 includes the subject matter of example 89, including or omitting optional elements, wherein the one or more processors are configured to reset the CWS to a minimum value in response to receiving a HARQ-ACK for at least a predetermined proportion of the TBs transmitted for the CAPC during the reference duration within the SL COT.

Example 92 includes the subject matter of example 89, including or omitting optional elements, wherein the one or more processors are configured to reset the CWS to a minimum value in response to receiving a HARQ-ACK for at least a predetermined proportion of code block groups (CBGs) for the TBs transmitted for the CAPC during the reference duration within the SL COT.

Example 93 includes the subject matter of example 89, including or omitting optional elements, wherein the one or more processors are configured to increase the CWS to a next value in response to receiving a HARQ-ACK for less than a predetermined proportion of the TBs transmitted for the CAPC during the reference duration within the SL COT.

Example 94 includes the subject matter of example 94, including or omitting optional elements, wherein the one or more processors are configured to increase the CWS according to (2*CWS+1).

Example 95 includes the subject matter of example 89, including or omitting optional elements, wherein the one or more processors are configured to increase the CWS to a next value in response to not receiving a HARQ-ACK for at least a predetermined proportion of code block groups (CBGs) for the TBs transmitted for the CAPC during the reference duration within the SL COT.

Example 96 includes the subject matter of example 95, including or omitting optional elements, wherein the one or more processors are configured to increase the CWS according to (2*CWS+1).

Example 97 includes the subject matter of example 89, including or omitting optional elements, wherein the one or more processors are configured to increase the CWS to a next value in response to receiving no HARQ-ACKs or HARQ-NACKs for the TBs transmitted for the CAPC during the reference duration within the SL COT; and not receiving a mode-1 transmission grant, or receiving retransmission grant, or a mode-2 transmission not occurring for TBs with the CAPC within a time window of predetermined length after expiration of a reference duration of an earliest SL COT since a last update of the CWS.

Example 98 includes the subject matter of example 97, including or omitting optional elements, wherein the one or more processors are configured to increase the CWS according to (2*CWS+1).

Example 99 includes the subject matter of example 97, including or omitting optional elements, wherein the predetermined length is determined according to max (TA, TB+1) milliseconds, where TA is 5 milliseconds and TB is the duration of the PSSCH from the start of the reference duration.

Example 100 includes the subject matter of example 89, including or omitting optional elements, wherein the one or more processors are configured to maintain the CWS at the current value in response to receiving no HARQ-ACKs or HARQ-NACKs for the TBs transmitted for the CAPC during the reference duration within the SL COT; and not receiving a retransmission grant, or receiving a mode-1 transmission grant, or a mode-2 transmission occurring for TBs with the CAPC during a time window of predetermined length after expiration of a reference duration of an earliest SL COT since a last update of the CWS.

Example 101 includes the subject matter of example 100, including or omitting optional elements, wherein the predetermined length is determined according to max (TA, TB+1) milliseconds, where TA is 5 milliseconds and TB is the duration of the PSSCH from the start of the reference duration.

Example 102 includes the subject matter of example 89, including or omitting optional elements, wherein the reference duration includes a duration of a first slot of the SL COT.

Example 103 includes the subject matter of example 89, including or omitting optional elements, wherein the reference duration includes k continuous first full slots in the SL COT when the UE transmits x PSSCH in the SL COT.

Example 104 includes the subject matter of example 89, including or omitting optional elements, wherein the reference duration starts at a partial slot starting point of the SL COT and ends at a first full slot after the partial slot starting point of the SL COT.

Example 105 includes the subject matter of example 89, including or omitting optional elements, wherein the reference duration starts at a partial slot starting point of the SL COT and ends at partial slot end point of the PSSCH in the SL COT.

Example 106 includes the subject matter of example 89, including or omitting optional elements, wherein the reference duration starts at a partial slot starting point of the SL COT and ends k continuous full slots after the partial slot starting point of the SL COT when the UE transmits x multiple PSSCH for the CAPC in the SL COT.

Example 107 includes the subject matter of example 89, including or omitting optional elements, wherein the reference duration starts at a partial slot starting point of the SL COT and ends at partial slot end point of a PSSCH burst in the SL COT when the UE transmits x multiple PSSCH for the CAPC in the SL COT.

Example 108 is an apparatus for a user equipment (UE) performing broadcast sidelink (SL) in unlicensed spectrum, including one or more processors configured to cause the UE to during a contention window having a contention window size (CWS), perform clear channel assessment (CCA) to acquire a SL channel occupancy time (COT); and during the SL channel occupancy time (COT), transmit respective signals encoding respective transport blocks (TBs) in one or more physical sidelink shared channels (PSSCHs) to one or more respective other UEs according to a broadcast protocol, wherein the one or more PSSCHs are associated with a channel access priority category (CAPC).

Example 109 includes the subject matter of example 108, including or omitting optional elements, wherein the CWS includes a CWS for unicast or groupcast SL communication being performed by the UE for the CAPC.

Example 110 includes the subject matter of example 108, including or omitting optional elements, wherein the CWS includes a preconfigured minimum CWS.

Example 111 includes the subject matter of example 108, including or omitting optional elements, wherein the CWS includes a preconfigured minimum CWS for the CAPC.

Example 112 includes the subject matter of example 108, including or omitting optional elements, wherein the one or more processors are configured to randomly select a value for the CWS.

Example 113 includes the subject matter of example 108, including or omitting optional elements, wherein the CWS includes a preconfigured minimum CWS for broadcast communication.

Example 114 includes the subject matter of example 108, including or omitting optional elements, wherein the CWS includes a preconfigured minimum CWS for broadcast communication for the CAPC.

Example 115 is a method that includes any action or combination of actions as substantially described herein in the Detailed Description.

Example 116 is a method as substantially described herein with reference to each or any combination of the Figures included herein or with reference to each or any combination of paragraphs in the Detailed Description.

Example 117 is a user equipment configured to perform any action or combination of actions as substantially described herein in the Detailed Description as included in the user equipment.

Example 118 is a network node configured to perform any action or combination of actions as substantially described herein in the Detailed Description as included in the network node.

Example 119 is a non-transitory computer-readable medium that stores instructions that, when executed, cause the performance of any action or combination of actions as substantially described herein in the Detailed Description.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A user equipment (UE), comprising:
a transceiver;
a memory; and
a baseband processor coupled to the memory and configured to, when executing instructions stored in the memory, cause the UE to
during a sidelink (SL) channel occupancy time (COT), transmit, via the transceiver, one or more physical sidelink shared channel (PSSCH) transmissions to one or more respective receiving (RX) UEs according to a SL communication protocol, wherein each PSSCH transmission includes one or more transport blocks (TBs), and is associated with a channel access priority class (CAPC);
update a contention window size (CWS) for the CAPC based on feedback received with respect to the one or more PSSCH transmissions; and
transmit a subsequent PSSCH transmission associated with the CAPC based on the updated CWS.

2. The UE of claim 1, wherein the baseband processor is further configured to update the CWS in response to receiving Hybrid Automatic Repeat Request (HARQ) acknowledgement (ACK) or non-acknowledgement (NACK) feedback with respect to TBs transmitted with the CAPC during a reference duration within the SL COT.

3. The UE of claim 2, wherein the baseband processor is further configured to, when HARQ-ACK or HARQ-NACK feedback is not received, update the CWS based on whether a mode-1 transmission grant or retransmission grant is received or a mode-2 transmission occurs for TBs associated with the CAPC during a time window of predetermined length after the reference duration of an earliest SL COT since a last CWS update.

4. The UE of claim 2, wherein the baseband processor is further configured to reset the CWS to a minimum value in response to receiving a HARQ-ACK for at least one of the TBs transmitted for the CAPC during the reference duration within the SL COT.

5. The UE of claim 2, wherein the baseband processor is further configured to reset the CWS to a minimum value in response to receiving a HARQ-ACK for at least a predetermined proportion of the TBs or at least a predetermined proportion of code block groups (CBGs) for the TBs transmitted for the CAPC during the reference duration within the SL COT.

6. The UE of claim 2, wherein the baseband processor is further configured to increase the CWS to a next value in response to receiving a HARQ-ACK for less than a predetermined proportion of the TBs transmitted for the CAPC during the reference duration within the SL COT or in response to not receiving a HARQ-ACK for at least a predetermined proportion of code block groups (CBGs) for the TBs transmitted for the CAPC during the reference duration within the SL COT.

7. The UE of claim 2, wherein the baseband processor is further configured to adjust the CWS based at least in part on
receiving no HARQ-ACKs or HARQ-NACKs for the TBs transmitted for the CAPC during the reference duration within the SL COT.

8. The UE of claim 7, wherein baseband processor is further configured to increase the CWS according to (2*CWS+1).

9. The UE of claim 2, wherein the baseband processor is further configured to maintain the CWS at the current value in response to
receiving no HARQ-ACKs or HARQ-NACKs for the TBs transmitted for the CAPC during the reference duration within the SL COT.

10. The UE of claim 9, wherein the predetermined length is determined according to max (TA, TB+1) milliseconds, where TA is 5 milliseconds and TB is the duration of the PSSCH from the start of the reference duration.

11. The UE of claim 2, wherein the baseband processor is further configured to adjust the CWS for a CAPC on a per receiving (RX) UE basis, such that the CWS for a CAPC and RX UE is updated based on feedback received with respect to TBs transmitted to the RX UE during the reference duration.

12. The UE of claim 2, wherein the reference duration comprises a duration of a first slot of the SL COT.

13. (canceled)

14. The UE of claim 2, wherein
the reference duration comprises k continuous first full slots in the SL COT when the UE transmits x PSSCH in the SL COT; or
the reference duration starts at a partial slot starting point of the SL COT and ends at a first full slot after the partial slot starting point of the SL COT, at a partial slot end point of the PSSCH in the SL COT, k continuous full slots after the partial slot starting point of the SL COT when the UE transmits x multiple PSSCH for the CAPC in the SL COT, or at a partial slot end point of a PSSCH burst in the SL COT when the UE transmits x multiple PSSCH for the CAPC in the SL COT.

15. The UE of claim 1, wherein the baseband processor is further configured to, for each CAPC, increase a contention window size (CWS) to a next value in response to receiving a HARQ-NACK with respect to a TB transmitted during a reference duration to a group of RX UEs for the CAPC.

16. The UE of claim 1, wherein the baseband processor is further configured to reset the CWS to a minimum CWS value when the updated CWS exceeds a preconfigured maximum CWS value or after the UE has transmitted PSSCH according to a maximum CWS for a preconfigured period of time.

17. A user equipment (UE), comprising:
a transceiver;
a memory; and
a baseband processor coupled to the memory and configured to, when executing instructions stored in the memory, cause the UE to:
during a contention window for a channel access priority class (CPAC) having a fixed contention window size (CWS), via the transceiver, perform clear channel assessment (CCA) to acquire a sidelink occupancy time (SL COT); and
during the SL COT transmit signals encoding respective one or more transport blocks (TBs) in respective one or more physical sidelink shared channel (PSSCH) transmissions to a group of one or more RX UEs, wherein each PSSCH is associated with the CAPC.

18-23. (canceled)

24. A baseband processor, configured to perform operations comprising:
during a sidelink (SL) channel occupancy time (COT), causing transmission of one or more physical sidelink shared channel (PSSCH) transmissions to one or more respective receiving (RX) UEs according to a SL communication protocol, wherein each PSSCH includes one or more transport blocks (TBs), and is associated with a channel access priority class (CAPC);
updating a contention window size (CWS) for the CAPC based on feedback received with respect to the one or more PSSCH transmissions; and
transmitting a subsequent PSSCH transmission associated with the CAPC based on the updated CWS.

25. (canceled)

26. (canceled)

27. The baseband processor of claim 24, the operations further comprising resetting the CWS to a minimum value in response to receiving a HARQ-ACK for at least one of the TBs transmitted for the CAPC during the reference duration within the SL COT and.

28. The baseband processor of claim 24, the operations further comprising resetting the CWS to a minimum value in response to receiving a HARQ-ACK for at least a predetermined proportion of the TBs or at least a predetermined proportion of code block groups (CBGs) for the TBs transmitted for the CAPC during a reference duration within the SL COT.

29-32. (canceled)

33. The baseband processor of claim 24, the operations further wherein the reference duration comprises a duration of a first slot of the SL COT.

34-37. (canceled)

38. The UE of claim 4, wherein the baseband processor is further configured to increase the CWS to a next level in response to receiving at least one HARQ-NACK and no HARQ-ACKs for TBs transmitted for the CAPC during the reference duration within the SL COT.
